(19) United States
(12) Patent Application Publication
(10) Pub. No.: US 2020/0098273 A1
(43) Pub. Date: Mar. 26, 2020

(54) SYSTEM AND METHOD FOR CONTROLLING PATROL OF DRONE, AND A RECORDING MEDIUM HAVING COMPUTER READABLE PROGRAM FOR EXECUTING THE METHOD

(71) Applicant: Se Jin KIM, Incheon (KR)

(72) Inventor: Se Jin KIM, Incheon (KR)

(21) Appl. No.: 16/575,919

(22) Filed: Sep. 19, 2019

(30) Foreign Application Priority Data
Sep. 20, 2018 (KR) 10-2018-0112795

(51) Int. Cl. G08G 5/00; B64C 39/02; G05D 1/10; G05D 1/00; G06K 9/00

(52) U.S. Cl. CPC G08G 5/0073; B64C 39/024; G05D 1/104; B64C 2201/127; G05D 1/0022; G06K 9/0063; G06K 9/00664; G05D 1/0088

(57) ABSTRACT

The drone control system includes a surveillance information receiver, a patrol drone mover, and a scout drone mover. The surveillance information receiver receives surveillance information from the patrol drone. The patrol drone mover moves the patrol drone to a preset patrol route. When the first event is confirmed from surveillance information, the first event is pursued by patrol drone. The scout drone mover moves the scout drone to the position of the patrol drone. According to such a configuration, by allowing patrol drones to patrol the patrol route to be preset, and to pursuit events found when an event such as a case or an accident occurs using a separate scout drone, a small number of drones can effectively monitor a large area.

### CROSS-REFERENCE TO RELATED APPLICATIONS

This U.S. non-provisional patent application claims priority under 35 U.S.C. § 119 of Korean Patent Application No. 10-2018-0112795, filed on Sep. 20, 2018, the entire contents of which are hereby incorporated by reference.

### BACKGROUND

The present invention relates to a control system and method, and more particularly, to a system and method for more effectively controlling the operation of a drone.

With the development of wireless communication technology and battery performance, proposed are a number of methods for remotely controlling drones and using them in real life and work. For example, a method of performing aerial photography using a drone or rapidly putting a drone in the event of a fire in a building or the like and extinguishing the fire early has been attempted.

However, in relation to the use of drones in such a manner, in most cases, sensor operation for drone movement and image capturing is performed manually by manpower. If the use of drones becomes active in the future and it is necessary to provide services using multiple drones, manual operation by manpower will adversely affect the distribution of drones and the quality of drone services.

Therefore, if it is necessary to continuous monitor certain areas such as crime prevention, boundary guard, fire monitoring, traffic control, etc., an automate drone operation is required, and for this, a drone control system to efficiently operate automated control with minimal drones is required.

In addition, the general use of drones is a limited use that is applied when the task to be performed is predetermined, and it is not fully utilized for the purpose of continuously monitoring the situation where the occurrence of an event is uncertain, such as crime prevention or security guard.

This is because if the drone is not located at the site when an event occurs, the danger situation cannot be monitored, and it requires too many drones to monitor all the wide areas all the time.

### SUMMARY

The present invention has been made to solve the above-mentioned conventional problems, and an object of the present invention is to provide a drone control system and method for effectively monitoring a wide area using a small number of drones.

In order to achieve the above object, the patrol drone control system according to the present invention includes a surveillance information receiver, a patrol drone mover, and a scout drone mover. The surveillance information receiver receives surveillance information from the patrol drone. The patrol drone mover moves the patrol drone to a preset patrol route. When the first event is confirmed from surveillance information, the first event is pursued by patrol drone. The scout drone mover moves the scout drone to the position of the patrol drone.

According to such a configuration, by allowing patrol drones to patrol the patrol route to be preset, and to pursue events confirmed when an event such as a case or an accident occurs using a separate scout drone, a small number of drones can effectively monitor a large area.

In addition, the patrol drone includes a first patrol drone and a second patrol drone. When the first event occurs, the patrol drone mover may pursue the first event with the second patrol drone, maintain patrol operation of the first patrol drone, and move the scout drone to the position of the second patrol drone. According to such a configuration, since the movement of patrol drone to the patrol route is not completely interrupted to take over event pursuit, the patrol's timeliness can be maintained.

Also, if the scout drone arrives at the position of the second patrol drone, the patrol drone mover may move the second patrol drone to the position of the first patrol drone. According to such a configuration, it is possible to cope with the further discovery of other events by restoring the state of patrol drones to a state prior to the event discovery after the takeover of event pursuit.

In addition, when the surveillance information receiver confirms the second event from the first patrol drone before the second patrol drone arrives at the position of the first patrol drone, the patrol drone mover may maintain the movement of the first patrol drone and move the second patrol drone to the second event location. According to such a configuration, the second patrol drone can be moved to the event occurrence position more quickly when a new event is found by omitting the return process of the second patrol drone.

In addition, when the surveillance information receiver confirms the second event from the first patrol drone before the second patrol drone arrives at the position of the first patrol drone, the patrol drone mover may pursue the second event with the first patrol drone and move the second patrol drone to the preset patrol route. According to such a configuration, it is possible to more surely perform the event pursuit of the Scout drone by preventing the gap of the event pursuit that can occur until the arrival of the second patrol drone.

In addition, the patrol drone includes a first patrol drone and a second patrol drone. When the first event occurs, the patrol drone mover may pursue the first event with the second patrol drone, maintain patrol operation of the first patrol drone, and move the scout drone to the position of the first patrol drone. According to such a configuration, if movement of the scout drone to the first patrol drone position is advantageous than to the second patrol drone position, by changing the roles of the scout drone and the second patrol drone, it is possible to increase the patrol efficiency.

For this, the system may further include a role setting changer for performing a setting for switching the roles of the scout drone and the second patrol drone. According to such a configuration, thereafter, the scout drone and the second patrol drone can be continuously used for the modified use.

In addition, if the surveillance information receiver confirms a second event from the first patrol drone before the second patrol drone whose role is changed from the scout drone arrives at the location of the first patrol drone, the patrol drone mover maintains the movement of the first patrol drone and moves the second patrol drone to the second event location.

In addition, if the surveillance information receiver confirms a second event from the first patrol drone before the second patrol drone whose role is changed from the scout drone arrives at the location of the first patrol drone, the patrol drone mover pursues the second event with the first patrol drone, and the second patrol drone moves the preset patrol route.

Furthermore, the system may further include a masking image generator for generating a masking image by masking an image included in the surveillance information. According to such a configuration, it is possible to limit the collected video information of the drone for privacy or confidentiality protection.

Moreover, disclosed are a patrol drone control system and method, and a recording medium having recorded thereon a computer readable program for executing the method.

### BRIEF DESCRIPTION OF THE FIGURES

FIG. 1 is a schematic block diagram of a patrol drone control system according to an embodiment of the present invention.

FIG. 2 is a diagram schematically showing a setting example of a patrol route and a base of a drone.

FIG. 3 is a diagram illustrating a warning algorithm for confirmation of an event occurrence and event pursuit.

FIGS. 4 and 5 are schematic flowcharts performed by the patrol drone and the scout drone in the Multi/Scouter formation operation (hereinafter, referred to as 1MS Formation) controlled by the control system of FIG. 1, respectively.

FIG. 6 is a diagram illustrating a state of use of 1MS Formation by way of example.

FIG. 7 is a flowchart for performing optimized alternating conditions.

FIGS. 8 and 10 are schematic flowcharts performed by the first patrol drone, the second patrol drone, and the scout drone in the Cruiser/Aux/Scouter formation operation (hereinafter, referred to as CAS Formation) controlled by the control system of FIG. 1, respectively.

FIG. 11 is a diagram illustrating a state of use of CAS Formation by way of example.

FIGS. 12 and 14 are schematic flowcharts performed by the first patrol drone, the second patrol drone, and the scout drone in the Multi-Main/Multi-Sub/Scouter formation operation (hereinafter, referred to as 2MS Formation) controlled by the control system of FIG. 1, respectively.

FIG. 15 is a diagram illustrating a state of use of 2MS Formation by way of example.

FIG. 16 is a schematic flowchart of a process for performing fuel filling of a drone.

FIGS. 17 and 18 are views illustrating examples in which operation types of different drones are combined in a downtown area and a highway area, respectively.

FIG. 19 illustrates an example of a layer hierarchy for drone operation.

FIG. 20 is a diagram showing an example of a layer composed of three-dimensions.

FIG. 21 is a diagram illustrating an example of a range of a layer and a bypass route.

FIG. 22 is a diagram illustrating a layer changing algorithm.

FIG. 23 is a diagram illustrating an example of masking in a 3D virtual space.

### DETAILED DESCRIPTION

Hereinafter, preferred embodiments of the present invention will be described with reference to the accompanying drawings.

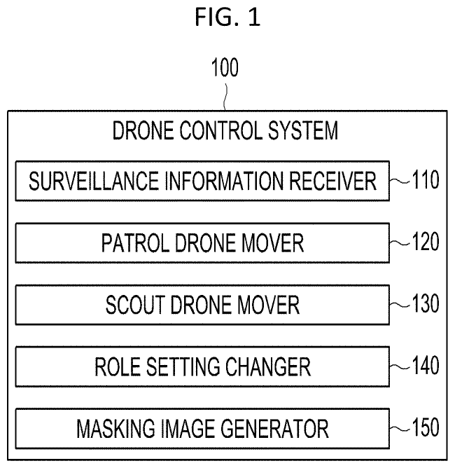

FIG. 1 is a schematic block diagram of a patrol drone control system according to an embodiment of the present invention. In FIG. 1, a drone control system 100 includes a surveillance information receiver 110, a patrol drone mover 120, a scout drone mover 130, a role setting changer 140, and a masking image generator 150. In FIG. 1, each component of the drone control system 100 may be implemented only in hardware, but it may be generally implemented together in hardware and software operating on the hardware.

The surveillance information receiver 110 receives surveillance information from the patrol drone, and the patrol drone mover 120 moves the patrol drone to a preset patrol route. At this time, the patrol route is a route set in advance by an administrator, and can be implemented in any form, and the patrol form of a drone can be implemented in any form, including flight, land or submerged underwater.

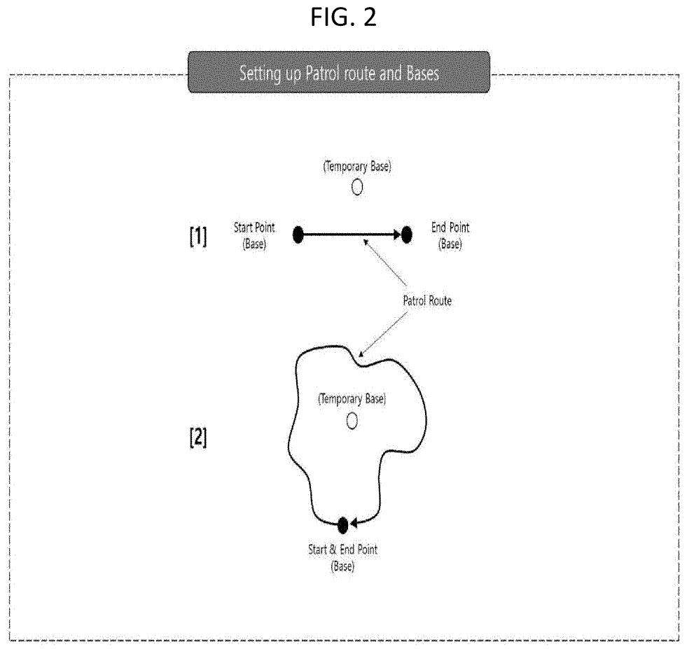

FIG. 2 is a diagram schematically showing a setting example of a patrol route and a base. As shown in FIG. 2, the start point and end point of the patrol drone (Cruiser or Multi) may be the same or different in the patrol route, and the two points are regarded as bases. Scouter drones may take off from or return to one or more bases and temporary bases.

The patrol drone mover 120 pursues the first event generated by the patrol drone when confirming the first event occurrence such as an event or an accident from the received surveillance information. Through this configuration, the formation operation of the drone squadron can be operated to confirm the event (operation for confirmation) or pursue it (pursuit operation) according to the warning of the situation or the administrator's arbitrary instructions.

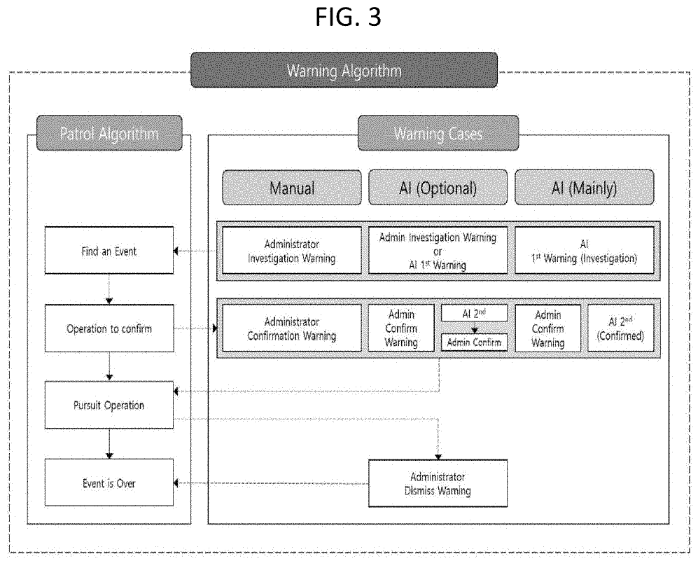

FIG. 3 is a diagram illustrating a warning algorithm for confirmation of an event occurrence and event pursuit. As shown in FIG. 3, the control system 100 may analyze the scan data of the drone using real time observation or AI, and if there is a problem event, trigger a warning, and observe or pursue a problem event.

Warnings can be implemented to include automatic warning (primary AI warning, secondary AI warning), administrator investigation warning, and administrator confirmation warning by the control AI system. In this case, AI 1st Warning is used when operating an AI system, and when a problem situation is found through the AI system from scan data at the time of general service, automatically execute AI 1st Warning to generate a ‘Find an event’ action in the flowchart.

AI 2nd Warning is used when operating the AI system. In the case of AI 1st warning or administrator investigation warning, operation of confirmation is performed, and at this time, AI 2nd warning is executed when determined as a problem situation from the scan data through the AI system.

If the AI cannot be completely reliable, it is regarded as preliminary ‘Confirmed’ before the administrator confirmation warning after performing the action of ‘Operation of confirmation’ in the flowchart. If the AI is completely reliable, it is the same as ‘Confirmed’ after the ‘Operation of confirmation’ action in the flowchart, and then pursuit operation is performed.

The Administrator Investigation Warning detects a problem event while the administrator directly monitors the scan data during normal operation and executes an administrator investigation warning to instruct an operation of confirmation. It is the same as the ‘Find an event’ action in the flowchart.

The Administrator Confirmation Warning is the same as ‘Confirmed’ after the ‘Operation of confirmation’ action in the flowchart, and then pursuit operation is performed.

Administrators can perform the Administrator Confirmation Warning immediately during constant monitoring. When AI 2nd warning occurs by the preset of the administrator, it immediately and automatically confirms and performs pursuit operation only for certain high priority situations, and in the case of low priority, the administrator can confirm the scan data and decide whether there is the Administrator Confirmation Warning. When AI 2nd warning occurs by the preset of the administrator, the administrator can confirm the scan data for all situations and decide whether there is the Administrator Confirmation Warning.

Administrator Dismiss Warning is a case where the event is terminated or the event is dismissed by an administrator, and generates an ‘Event is over’ action.

Depending on the frequency of warnings, the situation of the control center, and the reliability of the AI system, the administrator monitors the scan data of the normal operation or monitors the AI 1st warning or the AI 2nd warning to operate the control center efficiently.

At the same time as the Administrator Confirmation Warning, it notifies the management center or situation room of patrol personnel or police, etc., and thereafter, until the administrator (or control system) releases or terminates the situation, it uses Scouter drones to perform pursuit operations subsequently and monitors the site situation and cooperates with the control center or the situation room.

The scout drone mover 140 moves the scout drone separate from the patrol drone to the position of the patrol drone. According to such a configuration, by allowing patrol drones to patrol the patrol route to be preset, and to pursue events found when an event such as a case or an accident occurs using a separate scout drone, a small number of drones can effectively monitor a large area.

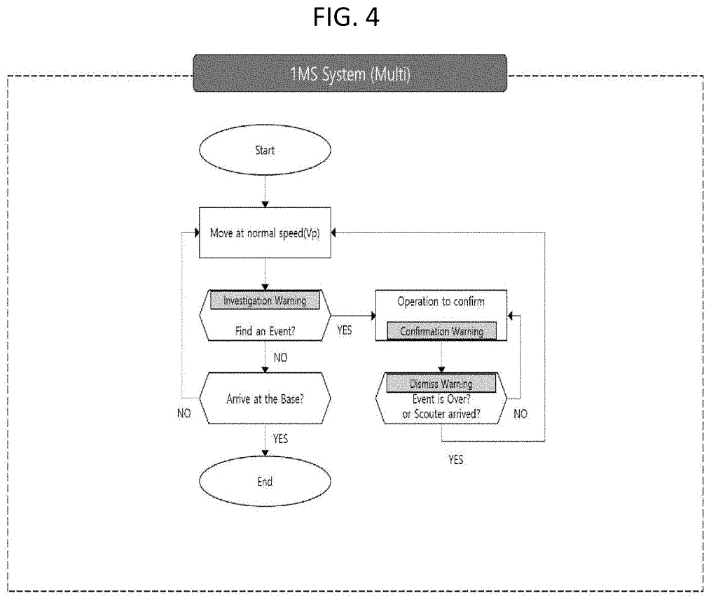

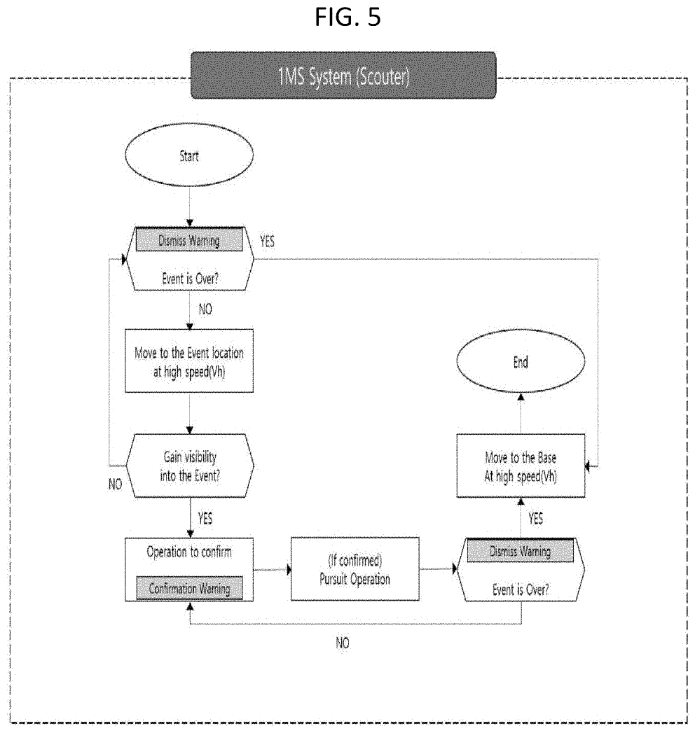

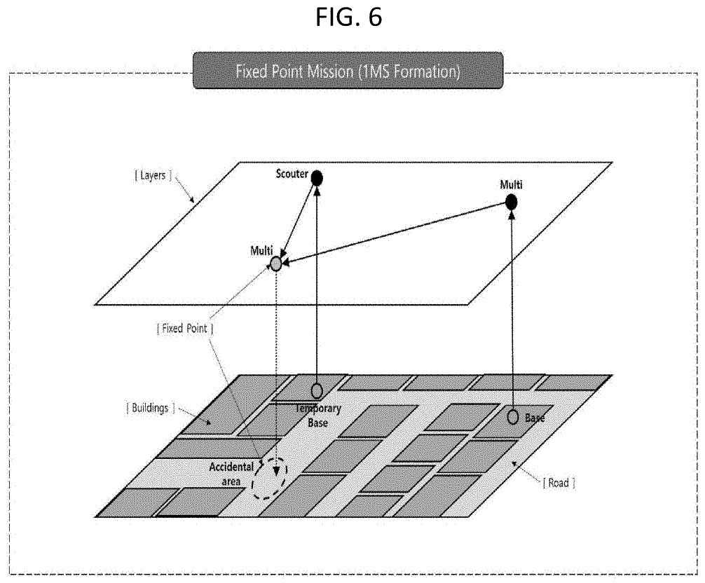

FIGS. 4 and 5 are schematic flowcharts performed by the patrol drone and the scout drone in the Multi/Scouter formation operation (hereinafter, referred to as 1MS Formation) controlled by the control system of FIG. 1, respectively. FIG. 6 is a diagram illustrating a state of use of 1MS Formation by way of example. ‘1MS Formation’ consists of one main patrol drone and zero or more Scouter drones, and is efficient when relatively few events are expected or when patrolling small areas or fixed points.

If the control center detects a warning event during normal operation for the main patrol mission, multi-drones (patrol drones) perform an operation of confirmation. After the Scouter drone reaches the event location, it performs a normal operation again.

If the control center detects a warning event while Scouter drones wait at the base, the Scouter drones move at high speed to the event location, and perform a confirmation flight for the occurrence event instead of the Multi drone in operation of confirmation. However, Scouter drones have priority over missions in order of proximity to the event location. It performs a pursuit operation for the event according to instructions of the control center.

The patrol drone includes a first patrol drone and a second patrol drone. When the first event occurs, the patrol drone mover 120 may pursue the first event with the second patrol drone, maintain patrol operation of the first patrol drone, and move the scout drone to the position of the second patrol drone. According to such a configuration, since the movement of patrol drone to the patrol route is not completely interrupted to take over event pursuit, the patrol's timeliness can be maintained.

Also, if the scout drone arrives at the position of the second patrol drone, the patrol drone mover 120 may move the second patrol drone to the position of the first patrol drone. According to such a configuration, it is possible to cope with the further discovery of other events by restoring the state of patrol drones to a state prior to the event discovery after the takeover of event pursuit.

At this time, when the surveillance information receiver 110 confirms the second event from the first patrol drone before the second patrol drone arrives at the position of the first patrol drone, the patrol drone mover 120 may maintain the movement of the first patrol drone and move the second patrol drone to the second event location. According to such a configuration, the second patrol drone can be moved to the event occurrence position more quickly when a new event is found by omitting the return process of the second patrol drone.

In addition, the patrol drone includes a first patrol drone and a second patrol drone. When the first event occurs, the patrol drone mover may pursue the first event with the second patrol drone, maintain patrol operation of the first patrol drone, and move the scout drone to the position of the first patrol drone. According to such a configuration, if movement of the scout drone to the first patrol drone position is advantageous than to the second patrol drone position, by changing the roles of the scout drone and the second patrol drone, it is possible to increase the patrol efficiency.

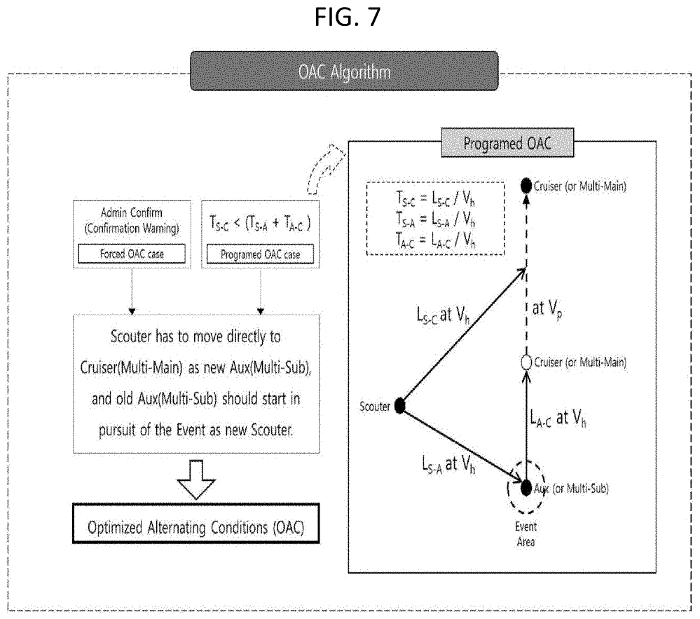

To this end, when the Scouter drone is operated, optimized alternating conditions as shown in FIG. 7 are automatically performed. FIG. 7 is a flowchart for performing optimized alternating conditions. However, if the event is confirmed by the Aux (Multi-sub) drone and the pursuit operation is urgent, the following optimized alternating condition (OAC) may be forcibly triggered by the administrator.

The role setting changer 140 performs a setting for switching the roles of the scout drone and the second patrol drone. According to such a configuration, thereafter, the scout drone and the second patrol drone can be continuously used for the modified use.

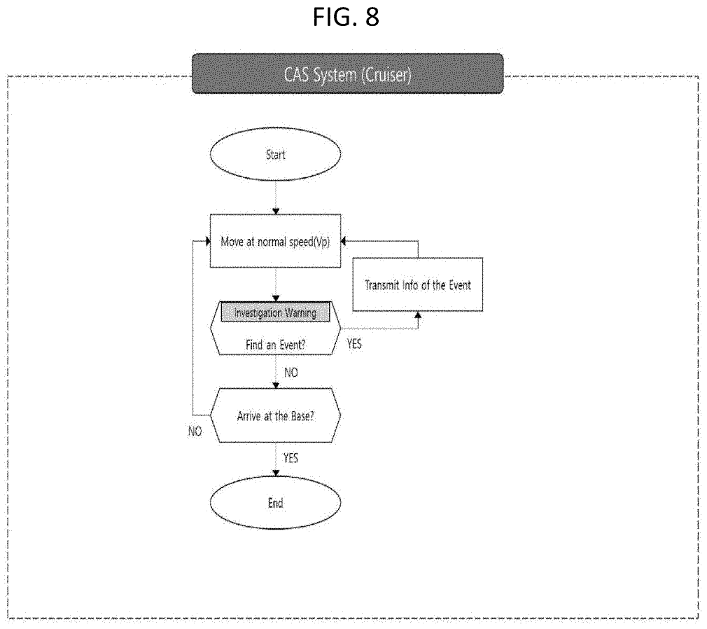

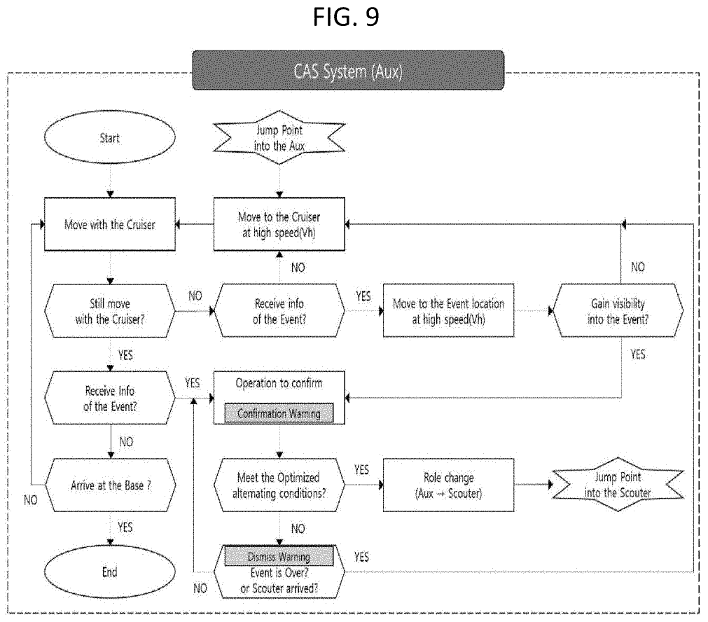

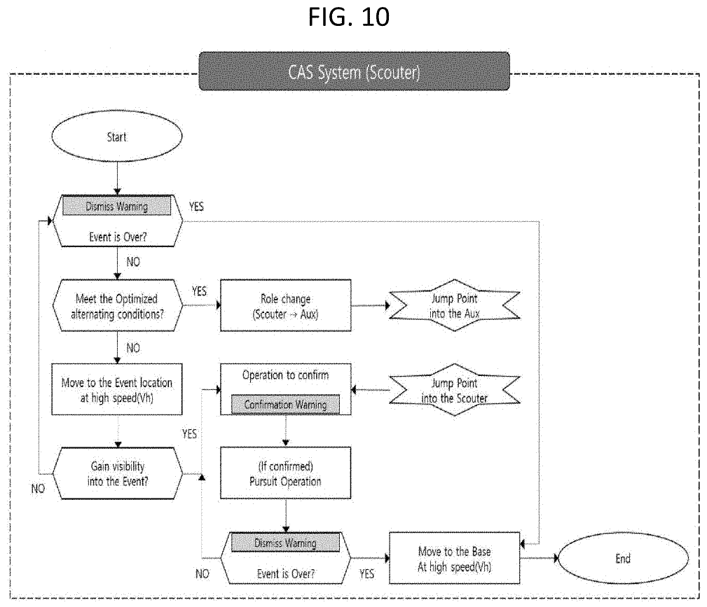

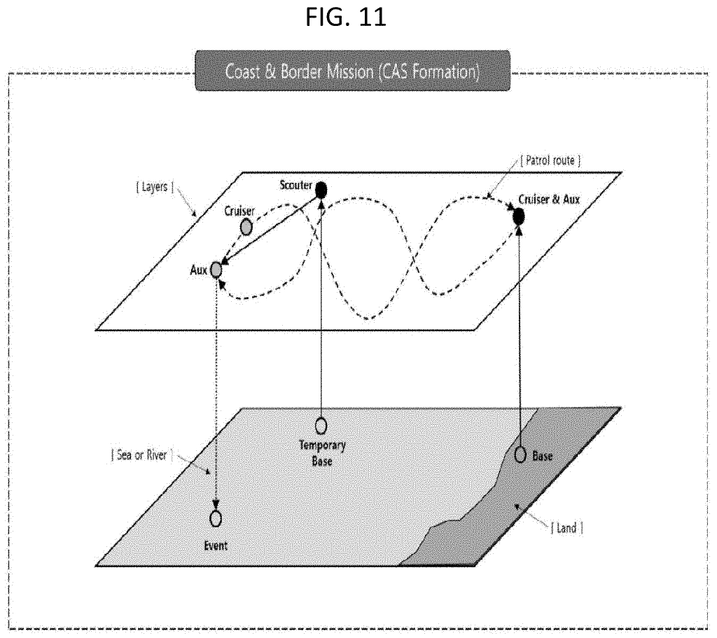

FIGS. 8 and 10 are schematic flowcharts performed by the first patrol drone, the second patrol drone, and the scout drone in the Cruiser/Aux/Scouter formation operation (hereinafter, referred to as CAS Formation) controlled by the control system of FIG. 1, respectively. FIG. 11 is a diagram illustrating a state of use of CAS Formation by way of example.

The CAS Formation includes one primary patrol drone (first patrol drone), one secondary patrol drone (second patrol drone), and zero or more Scouter drones. Efficient and reliable patrols are possible if the base is adjacent to a patrol route or if there are enough idle Scouter drones.

That is, it is suitable in a large city where a large number of events are expected and drone patrol infrastructure is easy to build. In addition, it is appropriate to apply to security and security areas where patrols and scouts must be completed without delay for patrol areas. However, if the idle Scouter drone is not enough, the main patrol move will not be delayed, but it cannot cope with many events.

Cruiser drones (primary patrol drones) can travel along a patrol route, stay while fixed at a predetermined point, take a random route, or be controlled by an administrator. This is called the main patrol move. At the same time as the main patrol moves, information (hereinafter referred to as scan data) scanned through the input sensor is transmitted to the control center in real time (hereinafter, normal operation).

If a problem situation (event) is found, it instructs the Aux drone for operation for confirmation, and if the Aux drone is not in normal operation, it transmits the situation occurrence scan data and the event location information of the event location to the Aux drone, and continuously performs normal operation. Specifically, the flowchart of FIG. 5 is followed.

If detecting a warning event during normal operation together with the Cruiser drone, it performs an operation for confirmation.

Thereafter, when the Scouter drone reaches the event location, it chases and returns to Cruiser drones with movement at high speed, and again performs normal operation with the Cruiser drone.

However, if the Cruiser drone detects another warning event before the chase is complete, it moves quickly to the corresponding situation point and immediately performs an operation for confirmation on the situation.

If the control center detects a warning event while Scouter drones wait at the base, the Scouter drones move at high speed to the event location, and perform an operation for confirmation instead of the Aux drone. However, it performs the optimized alternating conditions and missions are prioritized in order of proximity to the event location. It performs a pursuit operation for the event according to instructions of the control center.

In addition, when the surveillance information receiver 110 confirms the second event from the first patrol drone before the second patrol drone arrives at the position of the first patrol drone, the patrol drone mover 120 may pursue the second event with the first patrol drone and move the second patrol drone to the preset patrol route. According to such a configuration, it is possible to more surely perform the event pursuit of the Scout drone by preventing the gap of the event pursuit that can occur until the arrival of the second patrol drone.

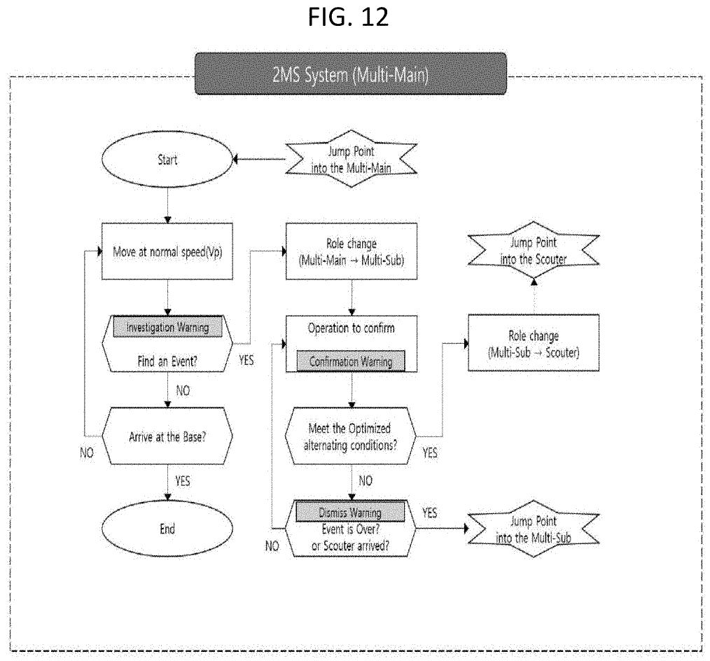

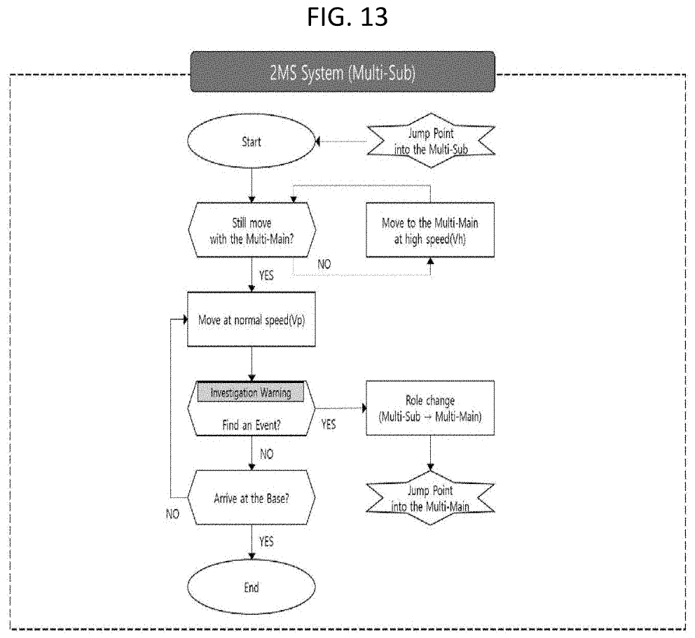

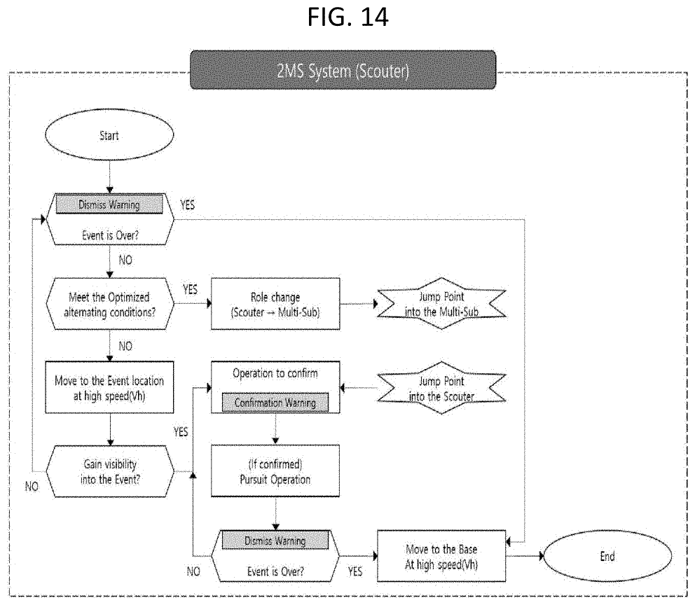

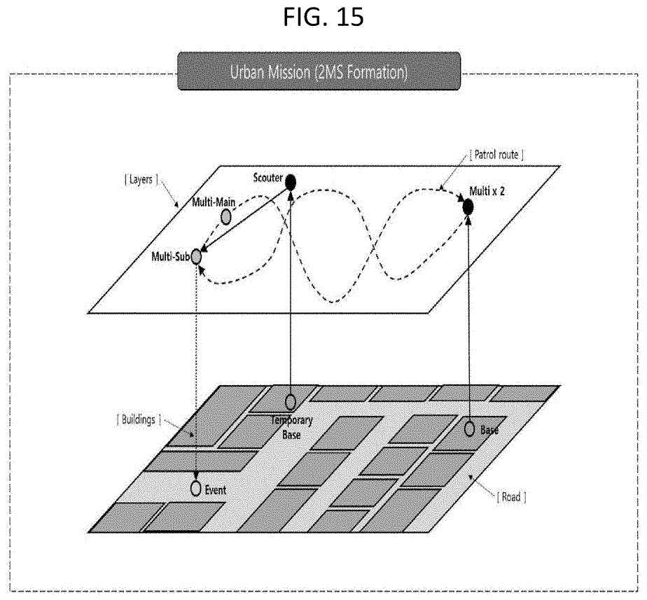

FIGS. 12 and 14 are schematic flowcharts performed by the first patrol drone, the second patrol drone, and the scout drone in the Main/Multi-Sub/Scouter formation operation (hereinafter, referred to as 2MS Formation) controlled by the control system of FIG. 1, respectively. FIG. 15 is a diagram illustrating a state of use of 2MS Formation by way of example.

The 2MS Formation includes two primary patrol drones (first patrol drone, second patrol drone) and zero or more Scouter drones.

Efficient patrols are possible even when the base is relatively less adjacent to the patrol route than the CAS and there are not enough idle Scouter drones. However, if more events occur consecutively than expected, the performance of the entire patrol mission may be delayed.

If the control center detects a warning event during normal operation together with a Multi-Sub drone (second patrol drone) for the main patrol move, the Multi-Main drone (first patrol drone) performs an operation of confirmation prior to the Multi-Sub drone. At this time, it changes the main patrol operation role with Multi-Sub (Main<->Sub).

Thereafter, when the Scouter drone reaches the event location, it pursues the Multi-Sub drone with movement at high speed to perform the role of Multi-Sub.

When the control center detects a warning event during normal operation of the Multi-Sub drone (second patrol drone) together with the Multi-Main drone, the Multi-Main drone first performs confirmation operation. At this time, it changes the main patrol operation role (Main<->Sub) with the Multi-Main so that the Multi-Sub drones (old) perform the main patrol mission.

If the control center detects a warning event while Scouter drones wait at the base, the Scouter drones move at high speed to the event location, and perform a confirmation flight for the occurrence event instead of the Multi-sub drone in operation of confirmation.

However, Scouter drones have priority over missions in order of proximity to the event location. It performs a pursuit operation for the event according to instructions of the control center.

On the other hand, all drones can be directly controlled by the administrator, can be excluded from existing operations, or can be operated by changing roles. In this case, the role setting changer 140 may change roles of various combinations as necessary.

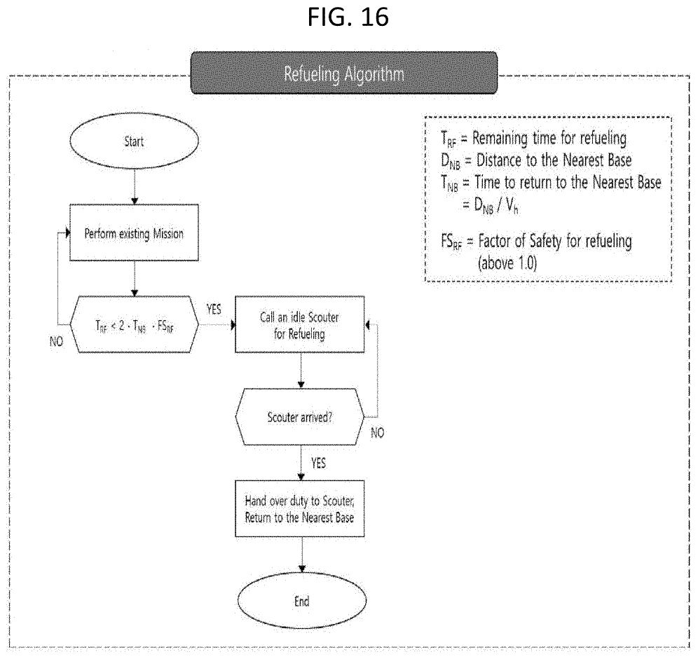

For example, in a case where mission completion is impossible in consideration of the remaining fuel calculated during the mission, when it calls an idle scouter at the shortest distance base or a temporary base and continues its mission and then, the scouter arrives, it hands over the existing mission to the scouter and moves to the shortest distance or temporary base at high speed and changes roles to an idle scouter. FIG. 16 is a schematic flowchart of a process for performing fuel filling of a drone.

In addition, if an over-mission warning by an administrator other than the event that the drone detects during normal operation occurs, idle scouter drones are dispatched at high speed. If the Aux (or Multi) drone is closer to the event location than the idle Scouter drone, it may change the role of the Aux (or Multi) drone into a Scouter drone and move to an event location at high speed.

At this time, the idle Scouter drone moves to the Cruiser (or Multi) drone at high speed to take over the role of Aux (or Multi). Furthermore, the Cruiser (or Multi) drone performs a multi-drone role of the 1MS algorithm until the idle Scouter drone arrives.

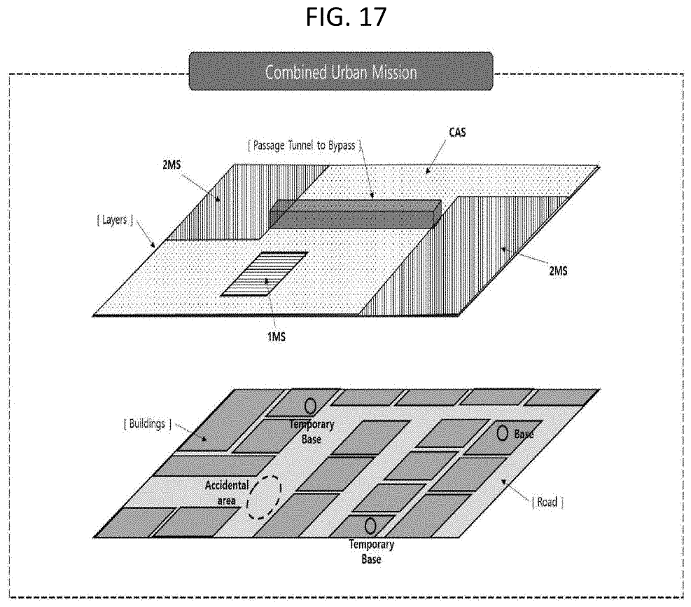

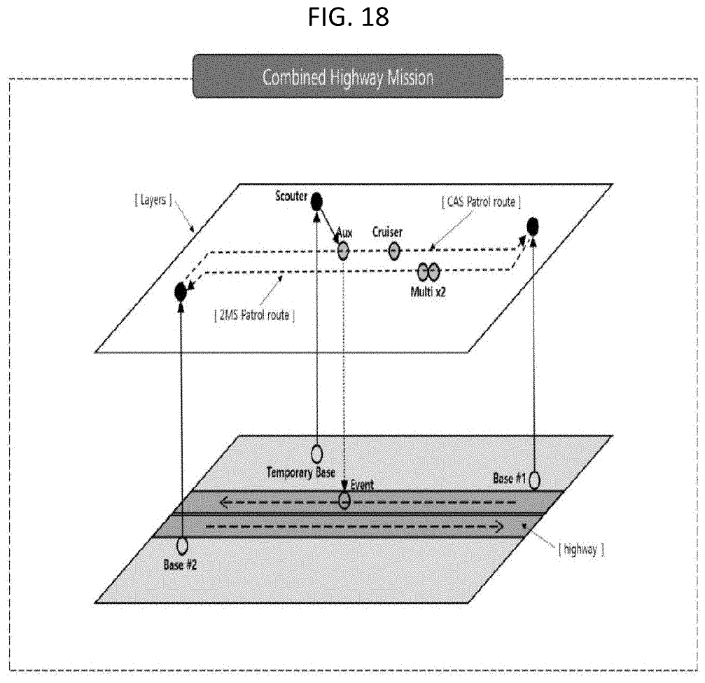

In addition, drone patrol operations may be performed in combination of the three types illustrated above. FIGS. 17 and 18 are views illustrating examples in which different types of operations are combined in a downtown area and a highway area, respectively.

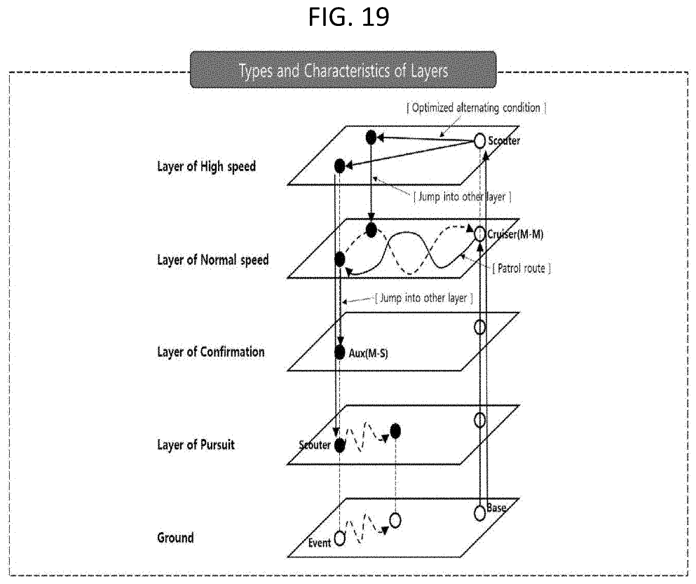

In addition, in the present invention, by operating the drone in a plurality of layers of different heights, it can prevent collisions and bottlenecks, and enable safe and efficient movement. FIG. 19 illustrates an example of a layer hierarchy for drone operation.

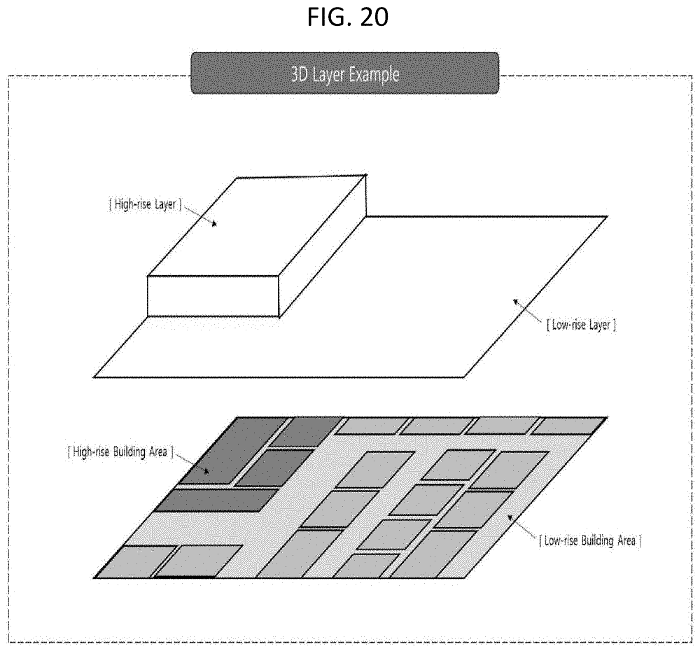

At this time, the vertical position between the layers can be changed according to the situation, and one layer may have a range. That is, there may be a thickness, and it may be configured in three-dimensions depending on the situation around the patrol target. FIG. 20 is a diagram showing an example of a layer composed of three-dimensions.

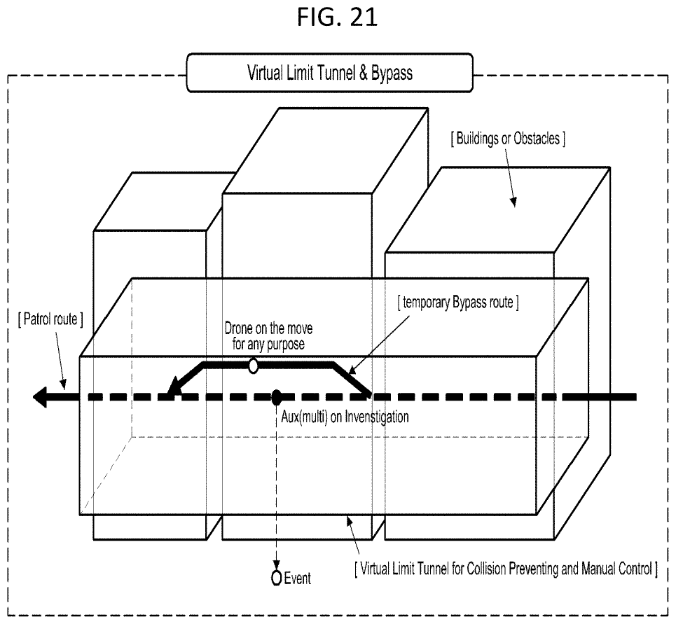

In addition, movement can be restricted to a virtual limit tunnel for manual manipulation within the layer or to prevent collisions with buildings or obstacles, and it is possible to generate and move a bypass route temporarily to avoid the drone in mission. FIG. 21 is a diagram illustrating an example of a range of a layer and a bypass route. Furthermore, the layer may limit the area according to the jurisdiction of the control center.

The type of a layer can be set as follows.

1) Normal flight layer: used for the normal operation. Generally travel along a confined course or route line along a road.

2) Confirmation flight layer: used for the above operation of confirmation. Typically travel a course with a limited width along the road.

3) High speed move layer: Used to operate as straight as possible to move to the destination simply fast. Used by Scouter drones for optimized alternating conditions or when Aux (Multi-Sub) drones return at high speed.

4) Pursuit layer: Used when continuous pursuit or observation of problem situation or action is required according to Administrator Confirmation Warning or administrator's arbitrary instruction.

Meanwhile, in order to prevent the drone from crashing when changing layers, the drone in layer change has priority over the drone in flight, and drones running on existing layers will wait at more than a preset safety limit distance from the layer changing drone, and can be configured to restart the operation after the layer change is completed.

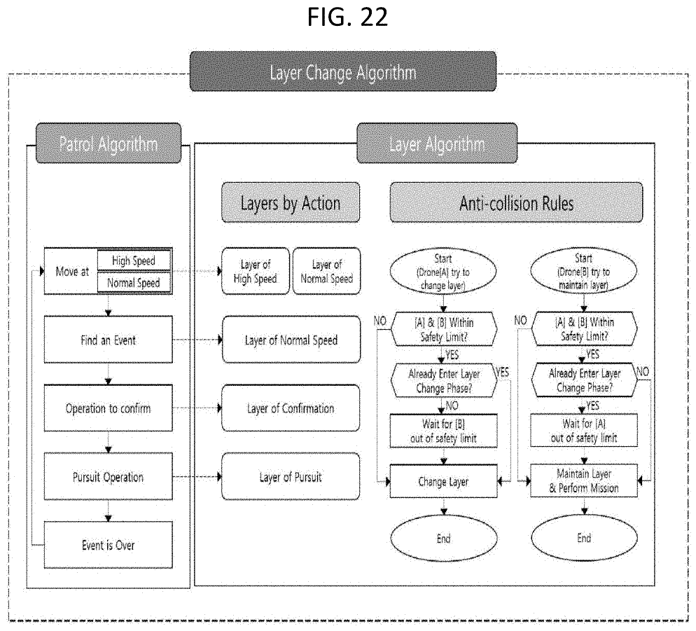

However, if already entered within the safety limit distance before attempting to change the layer, existing layer operation drones have priority, and the layer changing drone changes the layer after moving out of the safe limit distance, and moves to the target point after changing to the target layer. FIG. 22 is a diagram illustrating a layer changing algorithm.

The masking image generator 150 masks an image included in surveillance information to generate a masking image. The image received through the surveillance information receiver 110 may be outputted to the display terminal or stored in the storage device. This is to limit the drone's collected image information for privacy or confidentiality.

For this, in order to prevent image degradation caused by excessive masking, a uniform range (e.g., a cylinder with a measurement point reference radius of 500 m) within which masking operates is set from the measurement point coordinates, and it is possible to enable masking to operate within it. If only the object within the viewing angle is masked through the orientation information of the measurement point, it is possible to efficiently perform minimal masking.

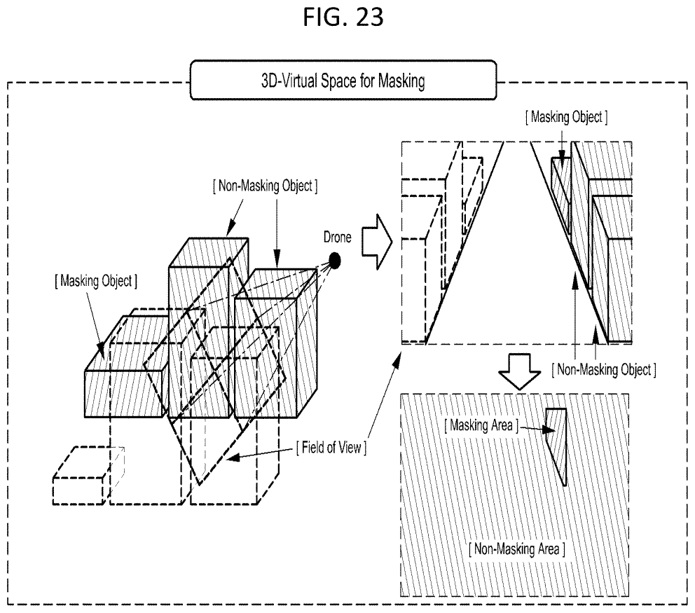

FIG. 23 is a diagram illustrating an example of masking in a 3D virtual space. In FIG. 23, an object with modeling or properties of a region covered with masking in a virtual space having 3D coordinates is called a masking object. The image with the measurement point coordinates (approximately the same as the drone position coordinates) and the viewing angle and azimuth information of the camera (sensor) for taking an image in the real space is called the actual image information. An image masked after merging and masking, with the actual image information, the screen of the virtual space where there is a masking object viewed from the point of view of the actual image information, which is outputted to the monitoring screen or is stored in a storage device is called masking image information.

As can be seen in FIG. 23, even if the masking object is not visible at the measurement point of view of the actual image information, an error that the masking object is seen in the monitored image may occur. Therefore, in order to prevent this, when configuring a virtual space with 3D coordinates, the non-masking object is also modeled. Then, when looking at the viewpoint of virtual space, in a case where a masking object and a non-masking object are overlapped, depending on which object is closer to the measurement point, the masked area is different as shown below.

1) Area where the non-masking object is closer to the measurement point of actual image information: output or store unmasked actual image information.

2) Area where the masking object is closer to the measurement point: output or store masked image information.

3) Area where only the real image exists without any object: output or store the unmasked actual image information.

According to the present invention, by allowing patrol drones to patrol the patrol route to be preset, and to pursue events found when an event such as a case or an accident occurs using a separate scout drone, a small number of drones can effectively monitor a large area.

In addition, since the movement of patrol drone to the patrol route is not completely interrupted to take over event pursuit, the patrol's timeliness can be maintained.

Furthermore, it is possible to cope with the further discovery of other events by restoring the state of patrol drones to a state prior to the event discovery after the takeover of event pursuit.

In addition, the second patrol drone can be moved to the event occurrence position more quickly when a new event is found by omitting the return process of the second patrol drone.

Moreover, it is possible to more surely perform the event pursuit of the Scout drone by preventing the gap of the event pursuit that can occur until the arrival of the second patrol drone.

Furthermore, if movement of the scout drone to the first patrol drone position is advantageous than to the second patrol drone position, by changing the roles of the scout drone and the second patrol drone, it is possible to increase the patrol efficiency.

Additionally, thereafter, the scout drone and the second patrol drone can be continuously used for the modified use.

In addition, it is possible to limit the collected video information of the drone for privacy or confidentiality protection.

Although the present invention is described by some preferred embodiments, the scope of the present invention should not be limited thereby, and it should have an effect on the modifications and improvements of the above-described embodiments supported by the claims.

What is claimed is:

1. A patrol drone control system comprising:
a surveillance information receiver configured to receive surveillance information from a patrol drone;
a patrol drone mover configured to move the patrol drone to a preset patrol route and pursue a first event with the patrol drone when confirming a first event occurrence from the surveillance information; and
a scout drone mover configured to move a scout drone to a location of the patrol drone.

2. The patrol drone control system of claim 1, wherein the patrol drone comprises a first patrol drone and a second patrol drone,
wherein the patrol drone mover pursues the first event with the second patrol drone when the first event occurs, and maintains a patrol operation of the first patrol drone,
wherein the scout drone mover moves the scout drone to the position of the second patrol drone.

3. The patrol drone control system of claim 2, wherein the patrol drone mover moves the second patrol drone to a position of the first patrol drone when the scout drone arrives at a position of the second patrol drone.

4. The patrol drone control system of claim 3, wherein if the surveillance information receiver confirms a second event from the first patrol drone before the second patrol drone arrives at the location of the first patrol drone, the patrol drone mover maintains the movement of the first patrol drone and moves the second patrol drone to the second event location.

5. The patrol drone control system of claim 3, wherein if the surveillance information receiver confirms a second event from the first patrol drone before the second patrol drone arrives at the location of the first patrol drone, the patrol drone mover pursues the second event with the first patrol drone, and the second patrol drone moves the preset patrol route.

6. The patrol drone control system of claim 1, wherein the patrol drone comprises a first patrol drone and a second patrol drone,
wherein the patrol drone mover pursues the first event with the second patrol drone when the first event occurs, and maintains the patrol operation of the first patrol drone,
wherein the scout drone mover moves the scout drone to the position of the first patrol drone.

7. The patrol drone control system of claim 6, further comprising a role setting changer for performing a setting for switching roles of the scout drone and the second patrol drone.

8. The patrol drone control system of claim 7, wherein if the surveillance information receiver confirms a second event from the first patrol drone before the second patrol drone whose role is changed from the scout drone arrives at the location of the first patrol drone, the patrol drone mover maintains the movement of the first patrol drone and moves the second patrol drone to the second event location.

9. The patrol drone control system of claim 7, wherein if the surveillance information receiver confirms a second event from the first patrol drone before the second patrol drone whose role is changed from the scout drone arrives at the location of the first patrol drone, the patrol drone mover pursues the second event with the first patrol drone, and the second patrol drone moves the preset patrol route.

10. The patrol drone control system of claim 1, further comprising a masking image generator for generating a masking image by masking an image included in the surveillance information.

11. A drone control method performed by a patrol drone control system, the method comprising:
moving, by a patrol drone mover, a patrol drone to a preset patrol route;
receiving, by a surveillance information receiver, surveillance information from the patrol drone;
pursuing a first event with the patrol drone when the patrol drone mover confirms an occurrence of the first event from the surveillance information; and
moving, by a scout drone mover, a scout drone to a location of the patrol drone.

12. The method of claim 11, wherein the patrol drone comprises a first patrol drone and a second patrol drone,
wherein the patrol drone mover pursues the first event with the second patrol drone when the first event occurs, and maintains a patrol operation of the first patrol drone,
wherein the scout drone mover moves the scout drone to the position of the second patrol drone.

13. The method of claim 12, further comprising moving, by the patrol drone mover, the second patrol drone to a position of the first patrol drone when the scout drone arrives at a position of the second patrol drone.

14. The method of claim 13, further comprising, if the surveillance information receiver confirms a second event from the first patrol drone before the second patrol drone arrives at the location of the first patrol drone, maintaining, by the patrol drone mover, the movement of the first patrol drone and moving the second patrol drone to the second event location.

15. The method of claim 13, further comprising, if the surveillance information receiver confirms a second event from the first patrol drone before the second patrol drone arrives at the location of the first patrol drone, pursuing, by the patrol drone mover, the second event with the first patrol drone, and moving, by the second patrol drone, the preset patrol route.

16. The method of claim 11, wherein the patrol drone comprises a first patrol drone and a second patrol drone,
further comprising: pursuing, by the patrol drone mover, the first event with the second patrol drone when the first event occurs, and maintaining the patrol operation of the first patrol drone; and
moving, by the scout drone mover, the scout drone to the position of the first patrol drone.

17. The method of claim 16, further comprising performing, by a role setting changer, a setting for switching roles of the scout drone and the second patrol drone.

18. The method of claim 17, further comprising, if the surveillance information receiver confirms a second event from the first patrol drone before the second patrol drone whose role is changed from the scout drone arrives at the location of the first patrol drone, maintaining, by the patrol drone mover, the movement of the first patrol drone and moving the second patrol drone to the second event location.

19. The method of claim 17, further comprising, if the surveillance information receiver confirms a second event from the first patrol drone before the second patrol drone whose role is changed from the scout drone arrives at the location of the first patrol drone, pursuing, by the patrol drone mover, the second event with the first patrol drone, and moving, by the second patrol drone, the preset patrol route.

20. A recording medium having recorded thereon a computer readable program for executing the method of claim 11.
